(19) United States
(12) Patent Application Publication
(10) Pub. No.: US 2024/0374460 A1
(43) Pub. Date: Nov. 14, 2024

(54) Visually Impaired Scanner Device

(71) Applicants: Ali Jackson, White Oak, PA (US); Heather Jackson, White Oak, PA (US)

(72) Inventors: Ali Jackson, White Oak, PA (US); Heather Jackson, White Oak, PA (US)

(21) Appl. No.: 18/514,419

(22) Filed: Nov. 20, 2023

Related U.S. Application Data
(60) Provisional application No. 63/500,822, filed on May 8, 2023.

(51) Int. Cl. A61H 3/06; G01S 19/01; G06F 1/16; G06T 7/60; G06V 10/20; H04W 76/45

(52) U.S. Cl. CPC A61H 3/061; G01S 19/01; G06F 1/163; G06T 7/60; G06V 10/255; H04W 76/45

(57) ABSTRACT

A visually impaired scanner device is disclosed for the blind to locate, identify, and maneuver their surroundings. The visually impaired scanner device comprises a body component that is configured as a small camera unit that can hang from a user's neck. The device has a camera option for scanning road signs, as well as sending pictures to people through a connected software application. Users can activate the scanner to identify their surroundings through the camera unit. The camera unit can send the information wirelessly to the software application for viewing. The helper can then communicate with the user and describe their current surroundings via the push-to-talk button. Thus, the device is specifically designed for a visually impaired audience, helping them navigate an indoor or outdoor environment.

### CROSS-REFERENCE TO RELATED APPLICATION

The present application claims priority to, and the benefit of, U.S. Provisional Application No. 63/500,822, which was filed on May 8, 2023, and is incorporated herein by reference in its entirety.

### FIELD OF THE INVENTION

The present invention relates generally to the field of visually impaired scanner devices. More specifically, the present invention relates to a camera and scanner system that can help visually impaired people navigate their surroundings. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, this invention relates to improvements in visually impaired scanner devices. Generally, visually impaired people may have trouble navigating independently in different environments regardless of their life experience. Further, being unaware of surroundings while in an urban area can lead to serious accidents and injuries. Additionally, traveling in unfamiliar areas may lead to accidentally falling down a set of steps or stepping off a curb without knowing.

People with a limited or absent sense of sight require an alternate method for recognizing and navigating their physical environment. In the past, such people had to rely on others, guide dogs, and canes for help navigating environments. People helpers are rarely available, and guide dogs and canes provide only a limited amount of information to the blind person. Dogs can help guide a person around obstacles or a pre-trained route. Canes provide information on the location of physical obstacles within immediate reach but do not provide any information on the identity of such obstacles, or how to navigate around them. Blind people resort to guesses based on contextual interpretation of their assumed physical environment.

Furthermore, a common problem encountered by a blind person is understanding a new and unfamiliar environment, for example when entering a room or space for the first time. A conventional approach for a blind person is to explore the walkable space with a cane and use tactile feedback to identify objects. This is very time-consuming, cumbersome, and potentially hazardous as the person can trip, bump into unexpected objects, touch dangerous surfaces such as a hot coffee maker or stove, etc. What is needed is a device to help a visually impaired person navigate their surroundings.

Accordingly, there is a demand for an improved scanner device that allows a camera to scan and survey an area, then transmit the information to an application to enable a visually impaired person to navigate their surroundings. More particularly, there is a demand for a device that allows a visually impaired person to communicate with others to obtain travel information.

Therefore, there exists a long-felt need in the art for a visually impaired scanner device that provides users with a camera and scanner system that can help visually impaired people navigate their surroundings. There is also a long-felt need in the art for a visually impaired scanner device that features a push-to-talk button near the camera scanner that can be used to wirelessly communicate with a software application controlled by a friend or family member. Further, there is a long-felt need in the art for a visually impaired scanner device that allows the camera to scan and survey the area, transmit the information to the application, and then enable the helper to communicate the information to the user through the push-to-talk button. Moreover, there is a long-felt need in the art for a device that prevents visually impaired people from being unaware of their surroundings and getting lost, injured, or both. Further, there is a long-felt need in the art for a visually impaired scanner device that comprises a small camera unit that can hang from a user's neck. Finally, there is a long-felt need in the art for a visually impaired scanner device wherein volume can be controlled via buttons on the side of the camera unit for easier hearing.

The subject matter disclosed and claimed herein, in one embodiment thereof, comprises a visually impaired scanner device. The device is a camera surveying device for the blind to locate, identify, and maneuver their surroundings. The visually impaired scanner device comprises a body component that is configured as a small camera unit that can hang from a user's neck. The device has a camera option for scanning road signs, as well as sending pictures to people through a connected software application. The device also includes a system of communicating with friends and family via a push-to-talk button. Users can activate the scanner to identify their surroundings through the camera unit. The camera unit can send the information wirelessly to the software application for viewing. The helper can then communicate with the user and describe their current surroundings via the push-to-talk button. Further, volume can be controlled via buttons on the side of the camera unit for easy hearing. Thus, the device is specifically designed for a visually impaired audience, helping them navigate an indoor or outdoor environment.

In this manner, the visually impaired scanner device of the present invention accomplishes all of the foregoing objectives and provides users with a device that provides a means for a visually impaired person to navigate their surroundings. The device is a camera unit that scans a user's environment and wirelessly transmits information via a connected software application. The device can hang from a user's neck.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a visually impaired scanner device. The device is a camera surveying device for the blind to locate, identify, and maneuver their surroundings. The visually impaired scanner device comprises a body component that is configured in a housing with a camera unit that can hang from a user's neck. The device has a camera option for scanning road signs, as well as sending pictures to people through a connected software application. Users can activate the scanner to identify their surroundings through the camera unit. The camera unit can send the information wirelessly to the software application for viewing. The helper can then communicate with the user and describe their current surroundings via the push-to-talk button. Thus, the device is specifically designed for a visually impaired audience, helping them navigate an indoor or outdoor environment.

In one embodiment, the visually impaired scanner device utilizes a software application that is utilized with a smart device (i.e., iPhone, iPad, Android phone, etc.) for mapping digital images based on orientation, processing images to identify objects and environmental features, and providing audio feedback responsive to user questions and inquiries. This device is advantageous for assisting blind and visually impaired people to identify the objects and features of a new and unfamiliar environment, such as upon entry into a new room or outside a new city, etc. Further, the device enables the identification of potentially hazardous or dangerous situations or objects in these new environments.

In one embodiment, the visually impaired scanner device comprises a body component that is configured in a housing that is typically rectangular in shape but can be any suitable size and shape as is known in the art. The housing generally comprises a top component, a bottom component, opposing side walls, and opposing front and back walls. The housing comprises a processing unit, which is communicatively coupled to a memory, a digital camera unit, positional sensors, a push-to-talk button, a power button, volume buttons, a battery, a speaker, at least one light, a transceiver, and a microphone. The housing also includes processing and logic circuitry (including a microcontroller or other suitable components and circuitry) that allows the components of the device to communicate with each other, as well as send alerts, flash the lights, and/or emit audible alarms, as needed, and allows the body component to communicate with a mobile smart device via a software application.

The mobile smart device has access to both computing power and information via wireless connectivity to an external source, as well as locally, with network connectivity. Further, computer processing and information can come from the mobile device itself.

Additionally, the body component comprises logic circuitry to communicate with the device components to; 1) monitor the location of the device; 2) generate and transmit alerts regarding the location of the user; 3) generate audible sounds; and 4) flash the lights. Optionally, the logic circuitry can also be programmed to monitor the battery and transmit a signal when the battery needs replacing. In one embodiment, the logic circuitry also comprises a microcontroller. The microcontroller is a small computer, often on a single integrated circuit, containing a processor core, memory, programmable input/output peripherals, and any other suitable components necessary for operation.

Furthermore, the body component comprises a transceiver, which is a communication device that transmits outbound alerts and receives inbound messages, as needed. The transceiver can be a Bluetooth or 802.11-based component or can be a cellular device that transmits messages via text messaging (SMS) services (i.e., SMS chip). Further, in one embodiment, the transceiver is a device that is used to transmit and receive radio signals. A user utilizes the push-to-talk button to transmit audible messages to a user of the mobile smart device.

Furthermore, the body component comprises a microphone. The microphone comprises at least one speaker for emitting an audible sound, alarm, noise, etc. The speaker can be any suitable speaker as is known in the art. The speaker can be waterproof or encased in a waterproof housing to protect it from the elements and/or emergency situations.

Additionally, the body component comprises at least one light. In another embodiment, there is a plurality of lights. The lights can flash, blink, and/or strobe depending on the alert being sent. Any suitable light can be utilized with the device, such as an LED, etc. The lights can be waterproof or encased in waterproof housing to protect them from the elements and/or emergency situations.

Generally, the body component also comprises a battery. The purpose of the battery is to provide electrical power for use by the device. The battery can be a rechargeable battery or any other suitable battery as is known in the art. In another embodiment, the battery is configured with a USB micro port (not shown) to allow for the programming of the device and charging of the battery.

Additionally, the body component comprises a location-tracking component. The location tracking component is a tracking component that is used to determine the location of the device. The location tracking component can be a GPS-based device that determines the location of the device using the Global Positioning System.

In one embodiment, the body component is secured within the housing and hung around a user's neck via a chain, a rope, a lanyard, etc. The housing can be any suitable shape and size as is known in the art, depending on the needs and/or wants of a user, and/or the size of the user wearing the device.

In operation, the body component, specifically, the logic circuitry and the transceiver are associated with a user's smartphone or other smart device that is designated to receive messages from the device. Specifically, the smart device utilizes a software application that communicates with the device to control the functions of the device. The software application allows a user to visualize the new location and/or environment. Further, additional alerts can be sent to and displayed on the smart device, such that a user is alerted if the user of the device is involved in an emergency and/or accident. The alerts would be sent to a user (of a paired smart device), as well as to emergency services, etc.

Specifically, the wireless communication module is in communication with a smart device and the visually impaired scanner device of the present invention. The visually impaired scanner device includes a wireless communications module and additional sensors which would allow the device to pair with a mobile application on a smart device. Once paired, a user could control the visually impaired scanner device via the mobile application. Furthermore, the mobile device or smart device may be a cellular telephone, an iPad, or any other device that may have wireless communication capabilities and may be connected to the internet. The mobile or smart device may perform any type of wireless communication, including, but not limited to, WIFI, BLUETOOTH, RFID, NFC, etc.

In operation, a blind or visually disabled user enters a room or a new or unfamiliar location. In one embodiment, the user would turn their body in a cyclical manner from left to right, scanning the scene similarly to how this would be done with a cane.

The user, using the body component and digital camera unit, acquires one or more images, videos, etc, of the location, which can then be stored in the memory. The images, videos, etc., are required for accurate spatial mapping. Therefore, a user may utilize a camera unit with multiple cameras (i.e., such as the dual cameras within the iPhone 7, etc.). Further, the body component and camera unit rely on object location and identification algorithms to obtain dimensional information by assuming typically expected dimensions for well-known everyday objects (i.e., chairs, vehicles, street crossings, doors, windows, etc.). The algorithms for mapping image points to corresponding 3D real space coordinates are then applied, based on the dimensional information obtained either from multiple images or from well-known everyday object size estimates. The information gathered with the body component and camera unit is then transmitted wirelessly to a mobile smart device via a software application.

It is advantageous for the processing of the environment to be sufficiently fast that a result is available within a reasonable time, such as within 1 min or less. Therefore, the amount of processing and available information will depend on the device. Preferentially, more information may be processed and provided on more powerful devices, and less information on less powerful ones.

Next, a virtual representation of the room or new location is mapped to the mobile smart device via the software application. And process completion is signaled to the user using a predefined audio tone via the speaker and/or vibration pattern. Once the process is complete, the information is wirelessly sent to a mobile smart device via a software application. Specifically, the device utilizes wireless data transmission means (for example by means of Wi-Fi, Bluetooth, or other similar technologies) connected to the processing unit to transmit data to the connected mobile smart device.

The software application then allows projection of the room or new location on the touch-sensitive screen of the mobile smart device. The user of the device then pushes the push-to-talk button and asks the corresponding user of the mobile smart device about the new environment. The mobile smart device user then informs the user of the device about their new environment. The mobile smart device user can then describe to the user of the device what they see (i.e., what is mapped on their smartphone via the software application). Thus, the mobile smart device user can describe and warn a device user of what to avoid and what is safe, etc. Accordingly, the device user can substantially explore the room or new location without physically moving through it, and thus, can understand the objects located in the location, their relative positions, dimensions and orientation, potential paths through the room, location of other doors, etc. The device user can also be presented with object attributes, such as potential tripping hazards, open/closed status of doors, potential appliance hazards, potential crosswalk hazards, etc.

In yet another embodiment, the visually impaired scanner device comprises a plurality of indicia.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the device described herein. Alternatively, some or all functions may be implemented by a state machine that has no stored program instructions, or in one or more application-specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer-readable code stored thereon for programming a computer, server, appliance, device, etc., each of which may include a processor to perform methods as described and claimed herein. Examples of such computer-readable storage mediums include but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in a non-transitory computer-readable medium, the software can include instructions executable by a processor that, in response to such execution, cause a processor or any other circuitry to perform a set of operations, steps, methods, processes, algorithms, etc.

In yet another embodiment, a method of scanning a user's surroundings and sending the information wirelessly to a software application for viewing is disclosed. The method includes the steps of providing a visually impaired scanner device comprising a body component configured in a housing with a small camera unit that hangs from a user's neck. The method also comprises scanning road signs and other environmental indicia via the camera unit. Further, the method comprises transmitting the information wirelessly to a software application for viewing. Finally, the method comprises communicating with a user to describe their current surroundings via a push-to-talk button.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the visually impaired scanner device of the present invention showing a user wearing the device in accordance with the disclosed architecture;

FIG. 2 illustrates a front perspective view of one embodiment of the visually impaired scanner device of the present invention showing the device with the camera unit in accordance with the disclosed architecture;

FIG. 3 illustrates a side perspective view of one embodiment of the visually impaired scanner device of the present invention showing the volume buttons of the camera unit and its communication with a mobile smart device in accordance with the disclosed architecture;

FIG. 4 illustrates a front perspective view of one embodiment of the visually impaired scanner device of the present invention showing how the device scans road signs and other environmental indicia in accordance with the disclosed architecture;

FIGS. 5A-B illustrate a perspective view of one embodiment of the visually impaired scanner device of the present invention showing how users can communicate with others through the device to obtain travel information in accordance with the disclosed architecture; and

FIG. 6 illustrates a flowchart showing the method of scanning a user's surroundings and sending the information wirelessly to a software application for viewing in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a visually impaired scanner device that provides users with a camera and scanner system that can help visually impaired people navigate their surroundings. There is also a long-felt need in the art for a visually impaired scanner device that features a push-to-talk button near the camera scanner that can be used to wirelessly communicate with a software application controlled by a friend or family member. Further, there is a long-felt need in the art for a visually impaired scanner device that allows the camera to scan and survey the area, transmit the information to the application, and then enable the helper to communicate the information to the user through the push-to-talk button. Moreover, there is a long-felt need in the art for a device that prevents visually impaired people from being unaware of their surroundings and getting lost, injured, or both. Further, there is a long-felt need in the art for a visually impaired scanner device that comprises a small camera unit that can hang from a user's neck. Finally, there is a long-felt need in the art for a visually impaired scanner device wherein volume can be controlled via buttons on the side of the camera unit for easier hearing.

The present invention, in one exemplary embodiment, is a novel visually impaired scanner device. The device is a camera surveying device for the blind to locate, identify, and maneuver their surroundings. The visually impaired scanner device comprises a body component that is configured as a small camera unit that can hang from a user's neck. The device has a camera option for scanning road signs, as well as sending pictures to people through a connected software application. Users can activate the scanner to identify their surroundings through the camera unit. The camera unit can send the information wirelessly to the software application for viewing. The helper can then communicate with the user and describe their current surroundings via the push-to-talk button. Thus, the device is specifically designed for a visually impaired audience, helping them navigate an indoor or outdoor environment. The present invention also includes a novel method of scanning a user's surroundings and sending the information wirelessly to a software application for viewing. The method includes the steps of providing a visually impaired scanner device comprising a body component configured in a housing with a small camera unit that hangs from a user's neck. The method also comprises scanning road signs and other environmental indicia via the camera unit. Further, the method comprises transmitting the information wirelessly to a software application for viewing. Finally, the method comprises communicating with a user to describe their current surroundings via a push-to-talk button.

Referring initially to the drawings, FIG. 1 illustrates a perspective view of one embodiment of the visually impaired scanner device 100 of the present invention. In the present embodiment, the visually impaired scanner device 100 is an improved visually impaired scanner device 100 that provides a user with a device that helps visually impaired people locate, identify, and navigate their surroundings. Specifically, the visually impaired scanner device 100 comprises a body component 102 configured within a housing 104 with a camera unit 106 that can hang from a user's neck 108. The device 100, via the camera unit 106, provides for scanning road signs, traffic lights, etc., as well as for sending pictures to people through a connected software application 110. The user 112 of the mobile device 114 can then communicate with the device user 116 and describe their current surroundings via a push-to-talk button 118. Thus, the device 100 is specifically designed for a visually impaired audience, helping them navigate an indoor or outdoor environment.

Generally, the visually impaired scanner device 100 utilizes a software application 110 that is utilized with a smart device 114 (i.e., iPhone, iPad, Android phone, etc.) for mapping digital images based on orientation, processing images to identify objects and environmental features, and providing audio feedback responsive to user questions and inquiries. This device 100 is advantageous for assisting blind and visually impaired people to identify the objects and features of a new and unfamiliar environment, such as upon entry into a new room or outside a new city, etc. Further, the device 100 enables the identification of potentially hazardous or dangerous situations or objects in these new environments.

Furthermore, the body component 102 of the device 100 is secured within the housing 104 and hung around a user's neck 108 via a chain 120, a rope, a lanyard, etc. The housing 104 can be any suitable shape and size as is known in the art, depending on the needs and/or wants of a user 116, and/or the size of the user 116 wearing the device 100.

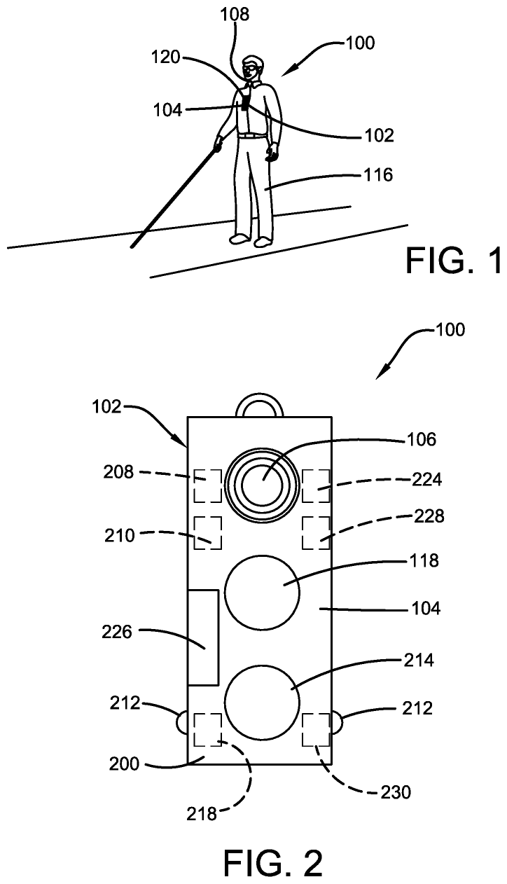

As shown in FIG. 2, the visually impaired scanner device 100 comprises a body component 102 that is configured in a housing 104 that is typically rectangular in shape but can be any suitable size and shape as is known in the art. The housing 104 generally comprises a top component 200, a bottom component 202, opposing side walls 204, and opposing front and back walls 206. The housing 104 comprises a processing unit 208, which is communicatively coupled to a memory 210, a digital camera unit 106, positional sensors 212, a push-to-talk button 118, a power button 214, volume buttons 216, a battery 218, a speaker 220, at least one light 222, a transceiver 224, and a microphone 226. The housing 104 also includes processing and logic circuitry 228 (including a microcontroller or other suitable components and circuitry) that allows the components of the device 100 to communicate with each other, as well as send alerts, flash the lights, and/or emit audible alarms, as needed, and allows the body component 102 to communicate with a mobile smart device 114 via a software application 110.

Furthermore, the mobile smart device 114 has access to both computing power and information via wireless connectivity to an external source, as well as locally, with network connectivity. Further, computer processing and information can come from the mobile device 114 itself.

Additionally, the body component 102 comprises logic circuitry 228 to communicate with the device components to: 1) monitor the location of the device 100; 2) generate and transmit alerts regarding the location of the user 116; 3) generate audible sounds; and 4) flash the lights. Optionally, the logic circuitry 228 can also be programmed to monitor the battery 218 and to transmit a signal when the battery 218 needs replacing. In one embodiment, the logic circuitry 228 also comprises a microcontroller (not shown). The microcontroller is a small computer, often on a single integrated circuit, containing a processor core, memory, programmable input/output peripherals, and any other suitable components necessary for operation.

Furthermore, the body component 102 comprises a transceiver 224, which is a communication device that transmits outbound alerts and receives inbound messages, as needed. The transceiver 224 can be a Bluetooth or 802.11 based component or can be a cellular device that transmits messages via text messaging (SMS) services (i.e., SMS chip). Further, in one embodiment, the transceiver 224 is a device that is used to transmit and receive radio signals. A user 116 utilizes the push-to-talk button 118 to engage the transceiver 224 to transmit audible messages to a user 112 of the mobile smart device 114.

Further, the body component 102 comprises a microphone 226. The microphone 226 comprises at least one speaker 220 for emitting an audible sound, alarm, noise, etc. The speaker 220 can be any suitable speaker as is known in the art. The speaker 220 can be waterproof or encased in a waterproof housing to protect it from the elements and/or emergency situations.

Additionally, the body component 102 comprises at least one light 222. In another embodiment, there is a plurality of lights 222. The lights 222 can flash, blink, and/or strobe depending on the alert being sent. Any suitable light 222 can be utilized with the device 100, such as an LED, etc. The lights 222 can be waterproof or encased in a waterproof housing to protect them from the elements and/or emergency situations.

Generally, the body component 102 also comprises a battery 218. The purpose of the battery 218 is to provide electrical power for use by the device 100. The battery 218 can be a rechargeable battery or any other suitable battery as is known in the art. In another embodiment, the battery 218 is configured with a USB micro port (not shown) to allow for programming of the device 100 and charging the battery 218.

Typically, the battery 218 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the visually impaired scanner device 100. Throughout this specification, the term “battery” may be used interchangeably to refer to one or more wet or dry cells or batteries of cells in which chemical energy is converted into electricity and used as a source of DC power. References to recharging or replacing the battery 218 may refer to recharging or replacing individual cells, individual batteries of cells, or a package of multiple battery cells as is appropriate for any given battery technology that may be used. In addition, a rechargeable embodiment of the battery 218 may be recharged using a USB port (not shown), wherein the USB port is a USB-A, USB-B, Micro-B, Micro-USB, Mini-USB, or USB-C port, etc.

Additionally, the body component 102 comprises a location tracking component 230. The location tracking component 230 is a tracking component that is used to determine the location of the device 100. The location tracking component 230 can be a GPS-based device that determines the location of the device 100 using the Global Positioning System.

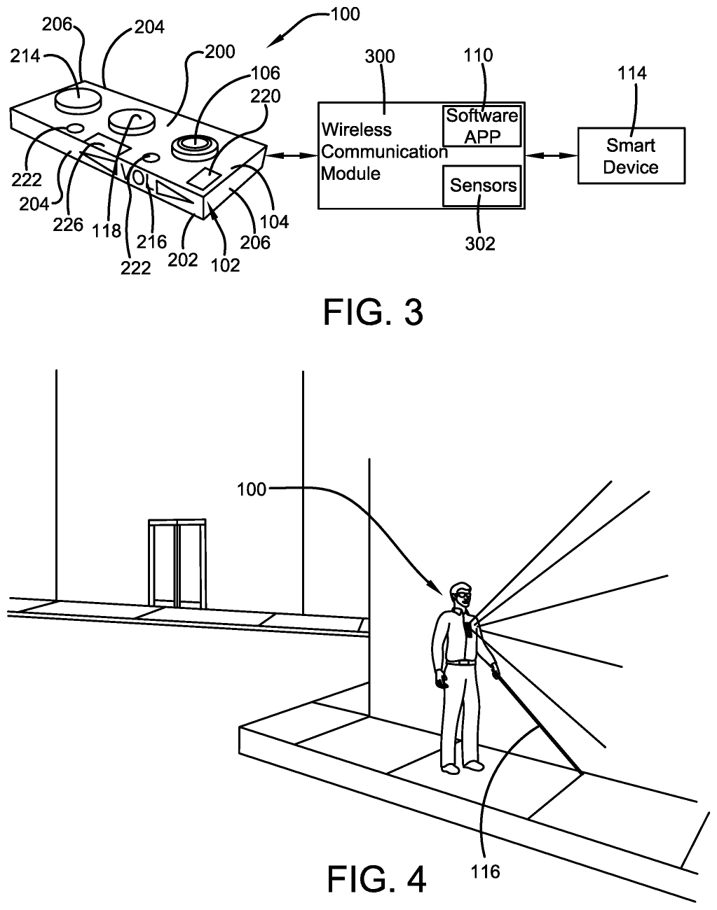

As shown in FIG. 3, in operation, the body component 102, specifically, the logic circuitry 228 and the transceiver 224 are associated with a user's smartphone 114 or another smart device that is designated to receive messages from the device 100. Specifically, the smart device 114 utilizes a software application 110 that communicates with the device 100 to control the functions of the device 100. The software application 110 allows a user 112 to visualize the new location and/or environment. Further, additional alerts can be sent to and displayed on the smart device 114, such that a user 112 is alerted if the device user 116 is involved in an emergency and/or accident. The alerts would be sent to a user 112 (of a paired smart device), as well as to emergency services, etc.

Specifically, the wireless communication module 300 is in communication with a smart device 114 and the visually impaired scanner device 100 of the present invention. The visually impaired scanner device 100 includes a wireless communications module 300 and additional sensors 302 which would allow the device 100 to pair with a mobile application 110 on a smart device 114. Once paired, a user 112 could control the visually impaired scanner device 100 via the mobile application 110. Furthermore, the mobile device 114 or smart device may be a cellular telephone, an iPad, or any other device that may have wireless communication capabilities and may be connected to the internet. The mobile or smart device 114 may perform any type of wireless communication, including, but not limited to, WIFI, BLUETOOTH, RFID, NFC, etc.

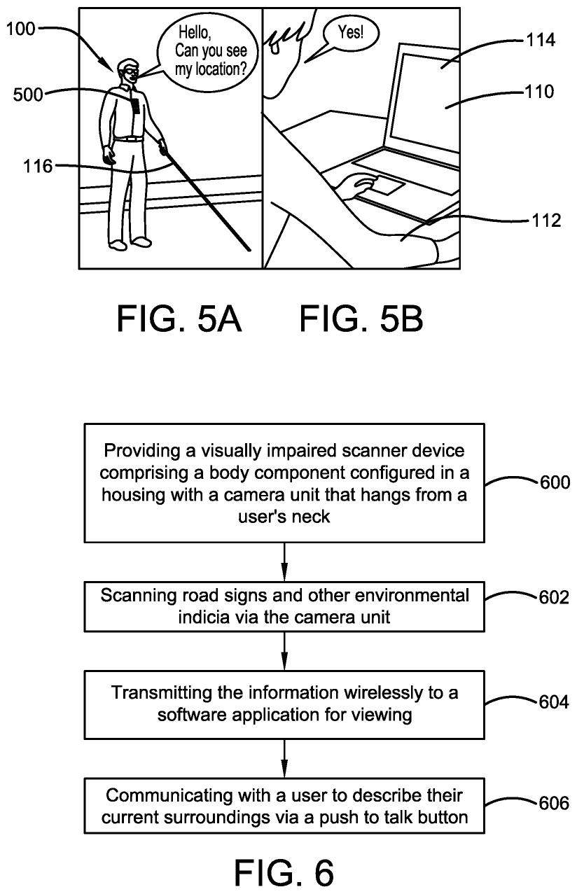

As shown in FIGS. 4 and 5A-B, in operation, a blind or visually disabled user 116 enters a room or a new or unfamiliar location. In one embodiment, the user 116 would turn their body in a cyclical manner from left to right, scanning the scene similarly to how this would be done with a cane.

The user 116, using the body component 102 and digital camera unit 106, acquires one or more images, videos, etc., of the location, which can then be stored in the memory 210. The images, videos, etc., are required for accurate spatial mapping. Therefore, a user 116 may utilize a camera unit 106 with multiple cameras (i.e., such as dual cameras within the iPhone 7, etc.). Further, body component 102 and camera unit 106 rely on object location and identification algorithms to obtain dimensional information by assuming typically expected dimensions for well-known everyday objects (i.e., chairs, vehicles, street crossings, doors, windows, etc.). The algorithms for mapping image points to corresponding 3D real space coordinates are then applied, based on the dimensional information obtained either from multiple images, or from well-known everyday object size estimates. The information gathered with the body component 102 and camera unit 106 is then transmitted wirelessly to a mobile smart device 114 via a software application 110.

It is advantageous for the processing of the environment to be sufficiently fast that a result is available within a reasonable time, such as within 1 min or less. Therefore, the amount of processing and available information will depend on the device 100. Preferentially, more information may be processed and provided on more powerful devices, and less information on less powerful ones.

Next, a virtual representation of the room or new location is mapped to the mobile smart device 114 via the software application 110. And process completion is signaled to the user 116 using a predefined audio tone via the speaker and/or vibration pattern. Once the process is complete, the information is wirelessly sent to a mobile smart device 114 via a software application 110. Specifically, the device 100 utilizes wireless data transmission means (for example by means of Wi-Fi, Bluetooth, or other similar technologies) connected to the processing unit 208 to transmit data to the connected mobile smart device 114.

The software application 110 then allows projection of the room or new location on the touch-sensitive screen of the mobile smart device 114. The user 116 of the device 100 then pushes the push-to-talk button 118 and asks the corresponding user 112 of the mobile smart device 114 about the new environment. The mobile smart device user 112 then informs the device user 116 about their new environment. The mobile smart device user 112 can then describe to the device user 116 what they see (i.e., what is mapped on their smartphone 114 via the software application 110). Thus, the mobile smart device user 112 can describe and warn a device user 116 of what to avoid and what is safe, etc. Accordingly, the device user 116 can substantially explore the room or new location without physically moving through it, and thus, can understand the objects located in the location, their relative positions, dimensions and orientation, potential paths through the room, location of other doors, etc. The device user 116 can also be presented with object attributes, such as potential tripping hazards, open/closed status of doors, potential appliance hazards, potential crosswalk hazards, etc.

In one embodiment, the visually impaired scanner device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be visually impaired, location, or brand related.

It will also be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the device described herein. Alternatively, some or all functions may be implemented by a state machine that has no stored program instructions, or in one or more application-specific integrated circuits (ASICs), in which each function or some combinations of certain functions are implemented as custom logic. Of course, a combination of the aforementioned approaches may be used. Moreover, some exemplary embodiments may be implemented as a non-transitory computer-readable storage medium having computer-readable code stored thereon for programming a computer, server, appliance, device, etc., each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like. When stored in a non-transitory computer-readable medium, the software can include instructions executable by a processor that, in response to such execution, cause a processor or any other circuitry to perform a set of operations, steps, methods, processes, algorithms, etc.

FIG. 6 illustrates a flowchart of the method of scanning a user's surroundings and sending the information wirelessly to a software application for viewing. The method includes the steps of at 600, providing a visually impaired scanner device comprising a body component configured in a housing with a camera unit that hangs from a user's neck. The method also comprises at 602, scanning road signs and other environmental indicia via the camera unit. Further, the method comprises at 604, transmitting the information wirelessly to a software application for viewing. Finally, the method comprises at 606, communicating with a user to describe their current surroundings via a push-to-talk button.

Certain terms are used throughout the following description and claims to refer to particular features or components. As one skilled in the art will appreciate, different users, may refer to the same feature or component by different names. This document does not intend to distinguish between components or features that differ in name but not structure or function. As used herein “visually impaired scanner device”, “scanner device”, “visually impaired device”, and “device” are interchangeable and refer to the visually impaired scanner device 100 of the present invention.

Notwithstanding the foregoing, the visually impaired scanner device 100 of the present invention can be of any suitable size and configuration as is known in the art without affecting the overall concept of the invention, provided that it accomplishes the above-stated objectives. One of ordinary skill in the art will appreciate the visually impaired scanner device 100 as shown in FIGS. 1-6 is for illustrative purposes only, and many other sizes and shapes of the visually impaired scanner device 100 are well within the scope of the present disclosure. Although the dimensions of the visually impaired scanner device 100 are important design parameters for user convenience, the visually impaired scanner device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A visually impaired scanner device that helps visually impaired users locate and navigate their surroundings, the visually impaired scanner device comprising:
a body component;
a housing; and
a camera unit;
wherein the body component is sized and configured to fit within the housing;
wherein the camera unit scans a user's surroundings and transmits data to a paired mobile smart device via a software application;
wherein the user communicates with a person of the paired mobile smart device via a push to talk button on the housing; and
further wherein the person of the paired mobile smart device communicates with the user to describe a user's current surroundings.

2. The visually impaired scanner device of claim 1, wherein the body component is configured to hang from a user's neck via a lanyard.

3. The visually impaired scanner device of claim 2, wherein the housing comprises a top component, a bottom component, opposing side walls, and opposing front and back walls.

4. The visually impaired scanner device of claim 3, wherein the housing comprises a processing unit, which is communicatively coupled to a memory, the camera unit, positional sensors, the push to talk button, a power button, volume buttons, a battery, a speaker, at least one light, a transceiver, and a microphone.

5. The visually impaired scanner device of claim 4, wherein the housing comprises processing and logic circuitry that allows components of the housing to communicate with each other.

6. The visually impaired scanner device of claim 5, wherein the transceiver transmits outbound alerts and receives inbound messages, as needed.

7. The visually impaired scanner device of claim 6, wherein the microphone comprises at least one speaker for emitting an audible sound.

8. The visually impaired scanner device of claim 7, wherein the at least one light can flash, blink, or strobe.

9. The visually impaired scanner device of claim 8, wherein the body component comprises a location tracking component for determining location of the housing.

10. The visually impaired scanner device of claim 9, wherein the housing comprises a wireless communications module and additional sensors which would allow the visually impaired scanner device to pair with the software application on the mobile smart device.

11. The visually impaired scanner device of claim 10, wherein the camera unit via the user, acquires one or more images or videos.

12. The visually impaired scanner device of claim 11, wherein the body component and the camera unit utilize object location and identification algorithms to obtain dimensional information by assuming typical expected dimensions for well-known everyday objects.

13. The visually impaired scanner device of claim 12, wherein the images or videos are processed and transmitted to the paired mobile smart device within 1 min or less.

14. A visually impaired scanner device that helps visually impaired users locate and navigate their surroundings, the visually impaired scanner device comprising:
a body component;
wherein the body component is configured within a housing with a camera unit;
wherein the housing comprises a top component, a bottom component, opposing side walls, and opposing front and back walls;
wherein the housing comprises a processing unit, which is communicatively coupled to a memory, the camera unit, positional sensors, the push to talk button, a power button, volume buttons, a battery, a speaker, at least one light, a transceiver, and a microphone;
wherein the housing comprises processing and logic circuitry that allows components of the housing to communicate with each other;
wherein the transceiver transmits outbound alerts and receives inbound messages, as needed;
wherein the microphone comprises at least one speaker for emitting an audible sound;
wherein the at least one light can flash, blink, or strobe;
wherein the housing comprises a wireless communications module and additional sensors which would allow the visually impaired scanner device to pair with a software application on a mobile smart device;
wherein the camera unit scan's a user's surroundings and acquires one or more images or videos to transmit to the mobile smart device via the software application;
wherein the body component and the camera unit utilize object location and identification algorithms to obtain dimensional information by assuming typical expected dimensions for well-known everyday objects;
wherein a user communicates with a person of the mobile smart device via a push to talk button on the housing; and
further wherein the person of the mobile smart device communicates with the user to describe a user's current surroundings, as well as object locations, their relative positions, dimensions and orientation, potential paths through the objects, as well as potential hazards and dangers.

15. The visually impaired scanner device of claim 14 further comprising a plurality of indicia.

16. The visually impaired scanner device of claim 14, wherein the body component is configured to hang from a user's neck via a lanyard.

17. The visually impaired scanner device of claim 14, wherein the images or videos are processed and transmitted to the mobile smart device within 1 min or less.

18. The visually impaired scanner device of claim 14, wherein the body component comprises a location tracking component for determining location of the housing.

19. The visually impaired scanner device of claim 14, wherein the volume buttons are positioned on a side of the housing and act to allow a user to control volume when using the push to talk button.

20. A method of scanning a user's surroundings and sending the information wirelessly to a software application for viewing, the method comprising the following steps:
providing a visually impaired scanner device comprising a body component configured in a housing with a small camera unit that hangs from a user's neck;
scanning road signs and other environmental indicia via the camera unit;
transmitting the information wirelessly to a software application for viewing; and
communicating with a user to describe their current surroundings via a push to talk button.
